(19) United States
(12) Patent Application Publication
(10) Pub. No.: US 2026/0269204 A1
(43) Pub. Date: Sep. 10, 2026

(54) OPEN PORT INTERFACE HAVING HYDROPHOBIC OR HYDROPHILIC PROPERTIES

(71) Applicant: DH Technologies Development Pte. Ltd., Singapore (SG)

(72) Inventors: Wan Ee ANG, Singapore (SG); Jing MA, Singapore (SG); Keat Lim LEE, Singapore (SG); Wayne SNG, Singapore (SG); Chang LIU, Richmond Hill (CA)

(73) Assignee: DH Technologies Development Pte. Ltd., Singapore (SG)

(21) Appl. No.: 18/876,251

(22) PCT Filed: Jun. 20, 2023
(86) PCT No.: PCT/IB2023/056384

§ 371 Date: Dec. 18, 2024

Related U.S. Application Data
(60) Provisional application No. 63/355,148, filed on Jun. 24, 2022.
(60) Provisional application No. 63/419,846, filed on Oct. 27, 2022.

(51) Int. Cl. H01J 49/04

(52) U.S. Cl. CPC H01J 49/0404; H01J 49/0454

(57) ABSTRACT

An open port interface includes an outer housing which defines an interior volume. A transport liquid port is communicatively coupled to the interior volume and configured to be fluidically coupled to a transport liquid pump. A removal conduit is disposed within the outer housing and fluidically coupled to the interior volume for removing a transport liquid from the interior volume. A sample inlet tip is removably coupled to the outer housing. The sample inlet tip defines a sample inlet port configured to receive a sample and communicatively coupled to the interior volume. At least a portion of the sample inlet tip proximate the sample inlet port includes a tip surface having a hydrophobicity different than a hydrophobicity of the outer housing.

### CROSS-REFERENCE TO RELATED APPLICATIONS

This application is being filed on Jun. 20, 2023, as a PCT International Patent Application that claims priority to and the benefit of U.S. Provisional Application Nos. 63/355,148, filed on Jun. 24, 2022, and 63/419,846, filed on Oct. 27, 2022, which is hereby incorporated by reference in their entireties.

### INTRODUCTION

An open-port interface (OPI) includes a co-axial dual-tube structure, where the inner tube is directly connected to the nebulizer-gas-assistant atmosphere pressure ion source of a mass spectrometer (MS) (e.g., electrospray ionization (ESI) or atmospheric pressure chemical ionization (APCI)). A low-pressure solvent pump may be used to deliver a continuous stream of solvent or transport liquid through the tubing annulus to the sampling port at the tip of the OPI. The transport liquid and sample are directly aspirated into the ion source, driven by the venturi aspiration force for the direct MS analysis. The OPI is a sampling interface that captures, mixes, and dilutes the captured sample with a transport liquid and delivers the resulting sample dilution to an ionization source for ionization. The benefits of both ambient ionization technologies such as high analytical throughput and simplified sample preparation, and the advantages of the classic ion sources of MS (e.g., ESI) including high sensitivity, reproducibility, and wide compound coverage, can be maintained simultaneously. Since its introduction, OPI has been used as a universal interface between different formats of raw samples and the classic ESI or APCI ion source of MS, including the direct sampling of tissues, laser ablation particles, solid phase microextraction (SPME) devices, magnetic particles, and aerosols. In addition, the OPI has been reported as a convenient MS sampling interface for discrete liquid droplets, from the nanoliter to the microliter range.

With the different relationship between the strength of the venturi aspiration and the solvent-in flow rate, four OPI fluid conditions at the capture region could be achieved. When the inlet flowrate is low, the fluid surface is deeply funneled with an air core in the OPI transfer tubing. In this supercritical condition, the air would disintegrate into segmenting bubbles, resulting into the unstable spray. On the other extreme, when the inlet flowrate is higher than the capacity of the aspiration rates the capture region is in a transition (a narrow range) mode, or dome condition. The fluid surface in the critical condition (flowrate higher than the supercritical condition but lower than the transition/dome condition) is the region where the fluid surface in the capture region is cone-shaped.

### SUMMARY

In one aspect, the technology relates to an open port interface including: an outer housing defining: an interior volume; and a transport liquid port communicatively coupled to the interior volume and configured to be fluidically coupled to a transport liquid pump; a removal conduit disposed within the outer housing and fluidically coupled to the interior volume for removing a transport liquid from the interior volume; and a sample inlet tip removably coupled to the outer housing, wherein the sample inlet tip defines a sample inlet port configured to receive a sample and communicatively coupled to the interior volume, wherein at least a portion of the sample inlet tip proximate the sample inlet port includes a tip surface having a hydrophobicity different than a hydrophobicity of the outer housing. In an example, the tip surface includes at least one of a one of a hydrophobic material, a hydrophobic coating, and a hydrophobic surface treatment. In another example, the sample inlet tip includes a ring-shaped terminal surface, wherein the ring-shaped terminal surface defines the sample inlet port, and wherein at least a portion of the ring-shaped terminal surface includes the tip surface having the hydrophobicity different than the hydrophobicity of the outer housing. In yet another example, the ring-shaped terminal surface includes an inner terminal surface region proximate the sample inlet port and an outer terminal surface region distal the sample inlet port. In still another example, the inner surface region includes the tip surface having the hydrophobicity different than the hydrophobicity of the outer housing.

In another example of the above aspect, the outer surface region includes the tip surface having the hydrophobicity different than the hydrophobicity of the outer housing. In an example, the sample inlet tip includes an inner wall defining a receiving volume fluidically coupled to the interior volume and the sample inlet port, and wherein at least a portion of the sample inlet tip inner wall includes the tip surface having the hydrophobicity different than the hydrophobicity of the outer housing. In another example, the tip surface includes at least one of a one of a hydrophilic material, a hydrophilic coating, and a hydrophilic surface treatment. In yet another example, the hydrophilic coating includes a nanoparticle coating. In still another example, the hydrophilic coating includes a coating of substantially isopropanol.

In another example of the above aspect, the hydrophilic surface treatment includes at least one microcapillary. In an example, the hydrophilic surface treatment includes a plurality of microcapillaries. In another example, the hydrophilic surface treatment includes a plasma treatment.

In another aspect, the technology relates to a method of manufacturing an open port interface (OPI), the method includes: providing an OPI outer housing and a removal conduit disposed within the OPI outer housing; identifying a transport liquid type based at least in part on an application of the OPI; providing a sample inlet tip of the OPI, wherein the sample inlet tip includes a sample inlet port having a sample inlet port geometry; and adjusting a hydrophobicity of the sample inlet tip based at least in part on the sample inlet port geometry and the identified transport liquid type. In an example, adjusting a hydrophobicity of the sample inlet tip includes selecting a desired sample inlet tip from a plurality of sample inlet tips, wherein each of the plurality of sample inlet tips includes a different hydrophobicity. In another example, the method further includes determining a desired liquid receiving volume at the sample inlet port, and wherein adjustment of the hydrophobicity is based at least in part on the determination of the desired liquid receiving volume.

In another aspect, the technology relates to a method of detecting a liquid overflow condition from a downward-facing open port interface (OPI), the method includes: providing the OPI which includes an outer housing, an interior volume, and a sample inlet tip defining a sample inlet port communicatively coupled to the interior volume; providing a sensor plate defining an opening, wherein at least a portion of the outer housing is at least partially within the opening, wherein the sensor plate includes a transport liquid sensor disposed on an upper surface of the sensor plate, and wherein the sample inlet port of the OPI is disposed below the upper surface; delivering a transport liquid to the interior volume of the OPI; and sending a signal from the transport liquid sensor upon contact between the transport liquid sensor and the transport liquid. In an example, the method further includes applying a hydrophilic treatment to the sample inlet tip. In another example, applying the hydrophilic treatment includes at least one of coating the sample inlet tip with a hydrophilic coating and texturing the sample inlet tip. In yet another example, texturing the sample inlet tip includes forming at least one microcapillary in the sample inlet tip.

In another aspect, the technology relates to a mass analysis system including: (a) a sensor plate including: an upper surface; a lower surface, wherein the sensor plate defines an opening from the upper surface to the lower surface; and a transport liquid sensor disposed adjacent the opening on the upper surface of the sensor plate; (b) a sample introduction system disposed below the lower surface; (c) a transport liquid pump; and (d) an open port interface including: an outer housing defining: an interior volume; and a transport liquid port communicatively coupled to the interior volume and configured to be fluidically coupled to the transport liquid pump; a removal conduit disposed within the outer housing and fluidically coupled to the interior volume for removing a transport liquid from the interior volume; and a sample inlet tip removably coupled to the outer housing, wherein the sample inlet tip defines a sample inlet port configured to receive a sample and communicatively coupled to the interior volume, wherein the sample inlet port is disposed below the upper surface, wherein at least a portion of the sample inlet tip proximate the sample inlet port includes a tip surface having a hydrophilicity different than a hydrophilicity of the outer housing, and wherein the transport liquid sensor contacts an exit volume of the transport liquid that exits the outer housing via the sample inlet port. In an example, the tip surface includes at least one of a hydrophilic material, a hydrophilic coating, and a hydrophilic surface treatment for moving the exit volume of the transport liquid towards the transport liquid sensor. In another example, the sample inlet port is disposed at least 0.5 mm below the lower surface of the sensor plate. In yet another example, the substrate includes a thickness of between about 0.5 mm and 0.8 mm. In still another example, a separation distance between the sample inlet tip and the upper surface is about 0.3 mm.

In another example of the above aspect, the hydrophilic coating includes a nanoparticle coating. In an example, the hydrophilic coating includes a coating of substantially isopropanol. In another example, the hydrophilic surface treatment includes at least one microcapillary. In yet another example, the hydrophilic surface treatment includes a plurality of microcapillaries. In still another example, the hydrophilic surface treatment includes a plasma treatment.

In another example of the above aspect, the sample introduction system includes a contactless ejection system.

### BRIEF DESCRIPTION OF THE DRAWINGS

FIG. 1 is a schematic view of an example system combining acoustic droplet ejection (ADE) with an open port interface (OPI) sampling interface and electrospray ionization (ESI) source.

FIG. 2A is an exploded perspective view of an OPI.

FIG. 2B is a partial enlarged schematic sectional view of the sample inlet tip of FIG. 2A.

FIG. 3 is a partial enlarged schematic sectional view of the sample inlet tip of FIG. 2B, displaying high hydrophobic performance.

FIG. 4 is a partial enlarged schematic sectional view of the sample inlet tip of FIG. 2B, displaying high hydrophilic performance.

FIG. 5 is a partial enlarged schematic sectional view of another example of a sample inlet tip.

FIG. 6 depicts formation of a liquid droplet at a sample inlet port of an OPI.

FIG. 7A depicts an apparatus for detecting droplets of liquid at a sample inlet port of an OPI.

FIG. 7B is an enlarged perspective view of a substrate of the apparatus of FIG. 7A.

FIG. 8 is a side view of an apparatus for detecting droplets of liquid at a sample inlet port of an OPI.

FIG. 9 depicts an example of an OPI in accordance with several examples.

FIG. 10 depicts a method for detecting liquid overflow from an OPI.

FIG. 11 depicts a method of manufacturing an OPI.

FIG. 12 depicts an example of a suitable operating environment in which one or more of the present examples can be implemented.

### DETAILED DESCRIPTION

The technologies described contemplate a sample inlet tip of an open port interface (OPI) that is characterized by a difference in hydrophilic or hydrophobic performance as compared to other portions of the OPI (e.g., the outer housing of the OPI or other portions of the sample inlet tip itself). The differences in hydrophilic or hydrophobic performance may be due to the use of a hydrophilic or hydrophobic material in sample inlet tip construction, the application of a hydrophilic or hydrophobic coating to the sample inlet tip (or a portion thereof), or by application of a hydrophilic or hydrophobic treatment to one or more surfaces of the sample inlet tip. Uses of sample inlet tips displaying particular performance characteristics are advantageous and numerous. In an example, increased hydrophilic performance may be used to control a transport liquid dome size to assist in the activation of the drip sensor when the dome forms and separates from the sample inlet tip. In another example, increased hydrophobic performance can increase a transport liquid dome size, which increases the dilution volume of the transport liquid within the OPI. This allows for increased dilution of the sample prior to aspiration from the OPI via the removal conduit.

Various OPI-based applications have distinct preferred fluid conditions. For example, formation of a sizable dome of transport liquid is desirable for nanoliter-sized droplet sampling (e.g., Acoustic Ejection Mass Spectrometry (AEMS)) to achieve the best peak-width and signal stability. The dome shape of the transport liquid at the port of the OPI is also relevant to the sampling of large volume droplet samples and the solid sample surface (e.g., SPME devices, tissue surface, etc.). In these examples, the size/volume of the transport liquid dome is relevant to the system/sampling performance.

As used herein, the terms “hydrophobic” and “hydrophilic” (as well as other terms based on similar root words) are relative and related terms. For example, a surface that displays a high hydrophobicity also simultaneously displays a low hydrophilicity. Further, surfaces described as displaying “high” or “low” hydrophobicity and/or hydrophilicity are generally compared to other identified surfaces or portions of surfaces. A person of skill in the art, upon reading this entire disclosure, would understand from the description of a particular sample inlet tip configuration and/or performance requirements, whether a surface of high hydrophobicity/low hydrophilicity, high hydrophilicity/low hydrophobicity is required for a particular application. For example, on a downward-facing OPI, surfaces that would benefit from retention of liquid thereon would display a high hydrophilicity (and, therefore, a low hydrophobicity). Conversely, on an upward-facing OPI, to increase a size of a transport liquid dome, surfaces displaying high hydrophobicity (and, therefore, low hydrophilicity) would aid in in the pooling of liquid on the sample inlet tip. Other examples of surfaces displaying particular fluid retention or repulsion characteristics are contemplated and described herein.

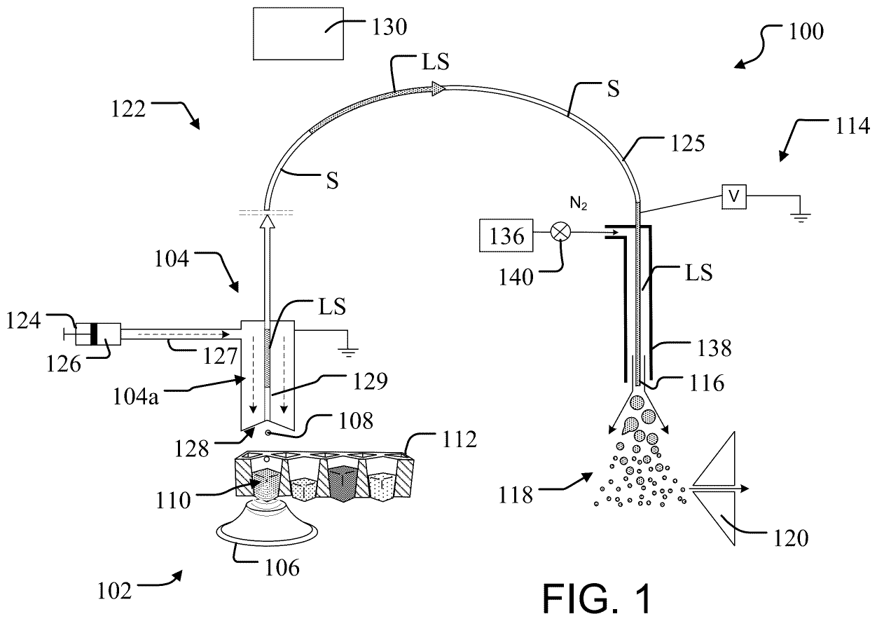

FIG. 1 is used for illustrative purposes to depict and locate the various components of an analysis system 100 relative to each other. Relevant to the present disclosure, the OPI 104 is in a downward-facing orientation, where a sample inlet 128 thereof faces downwards to receive a sample. Upward-facing orientations of the OPI 104 are also contemplated in such systems 100 and similar analysis systems, as would be known to a person of skill in the art.

For illustrative purposes, FIG. 1 is a schematic view of an example analysis system 100 combining an ADE 102 with an OPI sampling interface 104 and ESI source 114. The system 100 may be a mass analysis instrument such as a mass spectrometry device that is for ionizing and mass analyzing analytes received within an open end of the sampling OPI. Such a system 100 is described, for example, in U.S. Pat. No. 10,770,277, the disclosure of which is incorporated by reference herein in its entirety. The ADE 102 includes an acoustic ejector 106 that is configured to eject a droplet 108 from a reservoir of a well plate 112 into the open end of sampling OPI 104. Other contactless ejectors may also be utilized as may sample introduction systems that do not utilize ejection of samples.

As shown in FIG. 1, the example system 100 generally includes the sampling OPI 104 in liquid communication with the ESI source 114 for discharging a liquid containing one or more sample analytes (e.g., via electrospray electrode 116) into an ionization chamber 118, and a mass analyzer detector (depicted generally at 120) in communication with the ionization chamber 118 for downstream processing and/or detection of ions generated by the ESI source 114. Due to the configuration of the nebulizer nozzle 138 and electrospray electrode 116 of the ESI source 114, samples ejected therefrom are transformed into the gas phase. A liquid handling system 122 (e.g., including one or more pumps 124 and one or more transfer conduits 125) provides for the flow of liquid from a solvent reservoir 126 to the sampling OPI 104 and from the sampling OPI 104 to the ESI source 114. As ESI sources 114 allow for the formation of multiple charged ions and are, therefore, more applicable to a variety of applications, they are described within the application for consistency. The technologies described herein, however, may also be utilized for systems that incorporate a plurality of atmospheric pressure chemical ionization (APCI) sources.

The solvent reservoir 126 (e.g., containing a transport liquid solvent) can be fluidically coupled to the sampling OPI 104 via a supply conduit 127 through which the liquid can be delivered at a selected volumetric rate by the pump 124 (e.g., a reciprocating pump, a positive displacement pump such as a rotary, gear, plunger, piston, peristaltic, diaphragm pump, or other pump such as a gravity, impulse, pneumatic, electrokinetic, and centrifugal pump), all by way of non-limiting example. As discussed in detail below, the flow of liquid into and out of the sampling OPI 104 occurs within an internal volume 104a of the OPI 104 that is accessible at an open sample inlet 128 such that one or more samples 108 (here, in the form of sample droplets) can be introduced into a liquid boundary at the open sample inlet 128 and subsequently delivered to the ESI source 114. The liquid samples LS and solvent S exit the OPI 104 via a removal conduit 129 disposed therein and fluidically coupled to the transfer conduit 125. Further, flow out of the pump 124 may be adjusted, for example, based on the number of ESI sources 114 operating at a given time, or otherwise as required or desired for a particular application.

The system 100 includes an ADE 102 that is configured to generate acoustic energy that is applied to a liquid contained within a reservoir 110 that causes one or more droplets 108 to be ejected from the reservoir 110 into the open sample inlet 128 of the sampling OPI 104. A controller 130 can be operatively coupled to and configured to operate any aspect of the system 100. This enables the acoustic transducer of the ADE 106 to inject droplets 108 into the sampling OPI 104 as otherwise discussed herein substantially continuously or for selected portions of an experimental protocol by way of non-limiting example. As noted above other types of sample introduction systems may be utilized. ADE 102 and other non-contact ejection systems are particularly advantageous, however, because of the high sample throughput that may be achieved. Controller 130 can be, but is not limited to, a microcontroller, a computer, a microprocessor, or any device capable of sending and receiving control signals and data. Wired or wireless connections between the controller 130 and the remaining elements of the system 100 are not depicted but would be apparent to a person of skill in the art.

As shown in FIG. 1, the ESI source 114 can include a source 136 of pressurized gas (e.g., nitrogen, air, or a noble gas) that supplies a high velocity nebulizing gas flow to the nebulizer nozzle 138 that surrounds the outlet tip of the electrospray electrode 116. As depicted, the electrospray electrode 116 protrudes from a distal end of the nebulizer nozzle 138. The pressured gas interacts with the liquid discharged from the electrospray electrode 116 to enhance the formation of the sample plume and the ion release within the plume for sampling by mass analyzer detector 120, e.g., via the interaction of the high speed nebulizing flow and jet of liquid sample (e.g., analyte-solvent dilution). The liquid discharged may include liquid samples LS received from each reservoir 110 of the well plate 112. The liquid samples LS are diluted with the solvent S and may be separated from other samples by volumes of the solvent S depending on introduction rate of the liquid samples LS. As such, since flow of the solvent S moves the liquid samples LS from the OPI 104 to the ESI source 114, the solvent S may also be referred to herein as a transport liquid. The nebulizer gas can be supplied at a variety of flow rates, for example, in a range from about 0.1 L/min to about 40 L/min, which can also be controlled under the influence of controller 130 (e.g., via opening and/or closing valve 140).

It will be appreciated that the flow rate of the nebulizer gas can be adjusted (e.g., under the influence of controller 130) such that the flow rate of liquid within the sampling OPI 104 can be adjusted based, for example, on suction/aspiration force generated by the interaction of the nebulizer gas and the analyte-solvent dilution as it is being discharged from the electrospray electrode 116 (e.g., due to the Venturi effect/shock formation). The ionization chamber 118 can be maintained at atmospheric pressure, though in some examples, the ionization chamber 118 can be evacuated to a pressure lower than atmospheric pressure.

It will also be appreciated by a person skilled in the art and in light of the teachings herein that the mass analyzer detector 120 can have a variety of configurations. Generally, the mass analyzer detector 120 is configured to process (e.g., filter, sort, dissociate, detect, etc.) sample ions generated by the ESI source 114. By way of non-limiting example, the mass analyzer detector 120 can be a triple quadrupole mass spectrometer, or any other mass analyzer known in the art and modified in accordance with the teachings herein. Other non-limiting, exemplary mass spectrometer systems that can be modified in accordance with various aspects of the systems, devices, and methods disclosed herein can be found, for example, in an article entitled “Product ion scanning using a Q-q-Q linear ion trap (Q TRAP) mass spectrometer,” authored by James W. Hager and J. C. Yves Le Blanc and published in Rapid Communications in Mass Spectrometry (2003; 17:1056-1064); and U.S. Pat. No. 7,923,681, entitled “Collision Cell for Mass Spectrometer,” the disclosures of which are hereby incorporated by reference herein in their entireties.

Other configurations, including but not limited to those described herein and others known to those skilled in the art, can also be utilized in conjunction with the systems, devices, and methods disclosed herein. For instance, other suitable mass spectrometers include single quadrupole, triple quadrupole, ToF, trap, and hybrid analyzers. It will further be appreciated that any number of additional elements can be included in the system 100 including, for example, an ion mobility spectrometer (e.g., a differential mobility spectrometer) that is disposed between the ionization chamber 118 and the mass analyzer detector 120 and is configured to separate ions based on their mobility difference in high-field and low-field). Additionally, it will be appreciated that the mass analyzer detector 120 can comprise a detector that can detect the ions that pass through the analyzer detector 120 and can, for example, supply a signal indicative of the number of ions per second that are detected.

OPI sample transport flow relies on pressure differential set up across the transfer conduit 125 by nebulizer gas expanding past the transfer conduit 125 termination, e.g., at electrospray electrode 116, though nebulizers nozzles that do not use electrospray electrodes (e.g., APCI) are also contemplated for use with the technologies described herein. Nebulizer gas is expanding from the nebulizer nozzle 138, the nozzle size and nebulizer gas pressure determine the gas flowrate through the nozzle 138. Increasing the nebulizer gas flowrate generally improves the vacuum at the transfer conduit 125 termination and hence the pressure differential across the transfer conduit 125. Increasing the pressure differential (e.g., higher vacuum at the nozzle 138) increases the transport flow and improves sample throughput.

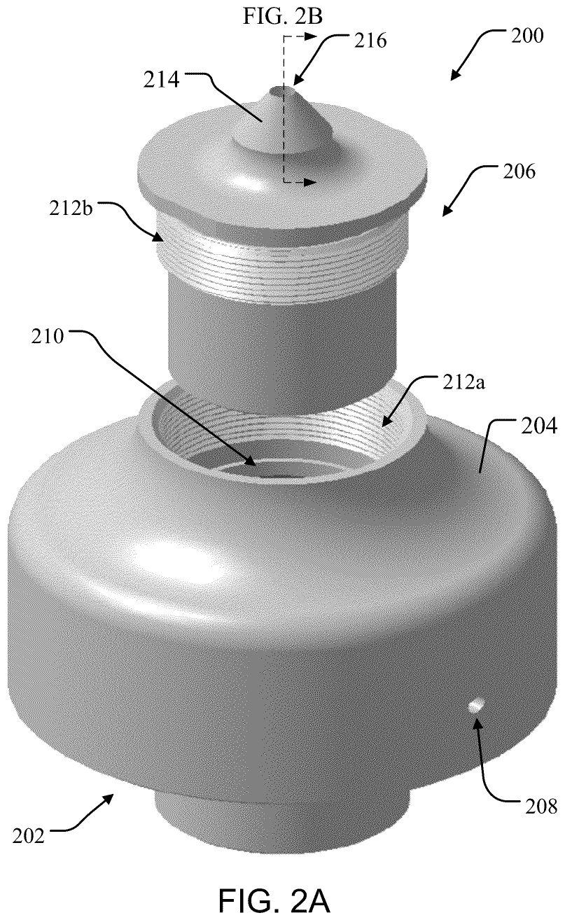

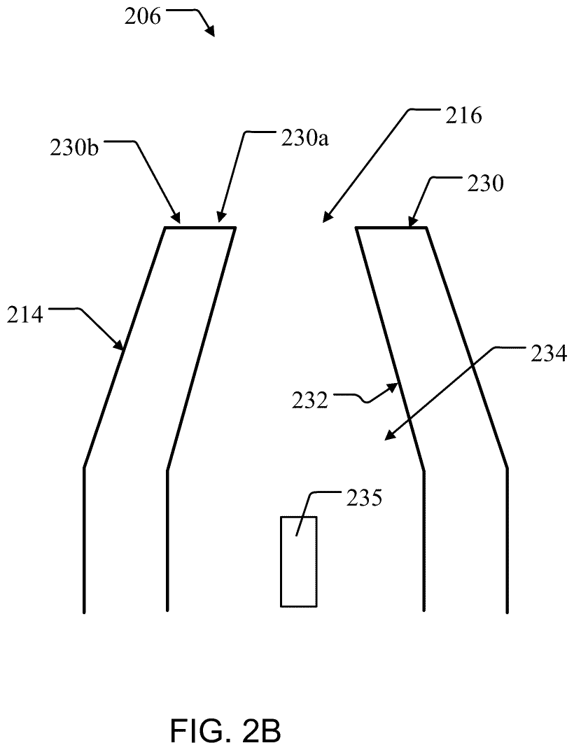

FIG. 2A is an exploded perspective view of an OPI 200. The OPI 200 includes a body 202 having an outer housing 204 and a sample inlet tip 206 removably coupled thereto. The outer housing 204 defines a transport liquid port 208 that is configured to be coupled to a transport liquid pump such as depicted in FIG. 1. The transport liquid port 208 is fluidically coupled to an interior volume 210 of the OPI 200, as defined by the outer housing 204. The interior volume 210 also houses the removal conduit (hidden from view in this figure, but depicted in FIG. 1). Mating threads 212a, 212b enable removable coupling of the sample inlet tip 206 to the outer housing 204, and, when completely engaged, completely seal the threaded interface so as to prevent leakage of liquid out of the OPI 200, or infiltration of air into the OPI 200. The sample inlet tip 206 includes an outer tip surface 214 that defines a sample inlet port 216 that is configured to receive a sample, such as described above and elsewhere herein. Various materials may be utilized for the sample inlet tip 206, such as a titanium alloy. Other materials compatible with the stainless steel body 202 may also be utilized.

FIG. 2B is a partial enlarged section view of the sample inlet tip 206 of FIG. 2A. the sample inlet tip 206 includes a number of surfaces that may display particularly desired hydrophobic or hydrophilic performance. The sample inlet tip 206 includes an outer tip surface 214. The sample inlet tip 206 includes a terminal surface 230 that may be described as round or ring-shaped and defines the sample inlet port 216. The terminal surface 230 may include multiple terminal surface regions, in this example an inner terminal surface region 230a that is proximate the sample inlet port 216 and an outer terminal surface region 230b that is distal the sample inlet port 216.

The sample inlet tip 206 also includes an inner wall 232 that defines a receiving volume 234 that is in fluidic communication with the interior volume of the outer housing of the OPI (depicted in FIG. 2A). Disposed within the receiving volume 234 is a removal conduit 235 for removing fluid therefrom. The width of the inner 230a and outer 230b terminal surface regions may vary as required or desired for a particular application. In examples, the inner terminal surface region 230a may represent up to 10% of the total terminal surface 230 width. N other examples, the width may be about 20%, about 30%, about 40%, about 50%, or greater than about 50% of the width.

The various surfaces and regions 214, 230, 230a, 230b, 232 may be characterized by a hydrophobicity different than that of the outer housing of the OPI, or of adjacent surfaces or regions of the sample inlet tip 206. The different hydrophobicity enables certain functionalities as described herein. For example, a sample inlet tip 206 having surfaces and/or regions of higher hydrophobicity may display different performance of transport liquid droplets that form at the sample inlet port 216. In one example, in an OPI having an upward-facing sample inlet tip 206 (such as depicted in FIG. 2B) with at least one surface or region with a high hydrophobicity, droplets of transport liquid having an enlarged size may be formed. This enlarged size can increase the size of the dome of the droplet that is formed at the receiving volume of the tip, which may alter dilution of a sample, may enable or improve the use of solid phase micro-extraction (SPME) devices, or otherwise allow for improved performance of the OPI.

The technologies described herein may also be utilized so as to control the shape of the liquid surface shape of the meniscus formed at the OPI, but using materials, coatings, or treatments to increase or decrease the volume of liquid that might extend from the OPI. The hydrophobic or hydrophilic technologies may also be utilized for other operational modes or directions. For example, the technologies may be applied to the OPI to control the meniscus dome size for the effective sampling of solid substrate surface, control of the surface sampling resolution, etc., such as described below.

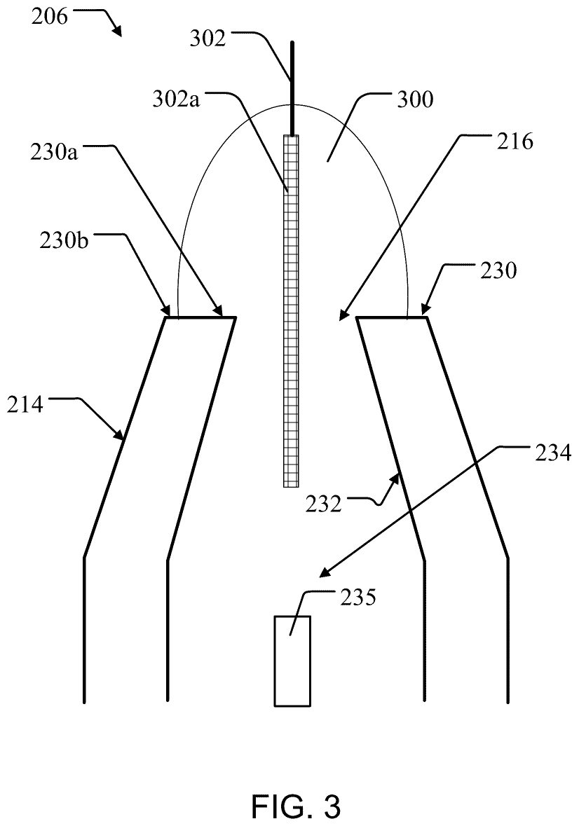

One such example is depicted in FIG. 3, where a sample inlet tip 206 having an outer terminal surface region 230b with a high hydrophobicity is depicted. In an example, the outer terminal surface region 230b has a higher hydrophobicity than an adjacent region (e.g., inner terminal surface region 230a), which causes an enlarged droplet 300 to form. Coupled with the amount of transport liquid present in the receiving volume 234, as well as the fluidically coupled interior volume of the OPI outer housing (not shown), the total dilution volume can be increased significantly. In certain examples, the receiving volume 234 of the sample inlet tip 206 and interior volume of the OPI may correspond to a volume of about 0.1 μL to about 5.0 μL, as measured to a plane defined by the sample inlet port 216 (e.g., even with the terminal surface 230). Depending on the surface performance desired, a high hydrophobicity on at least a portion of the tip surface 214 may form a droplet 300 volume (above the plane defined by the sample inlet port 216) of up to about several microliters, e.g., less than about 1.0 μL, less than about 1.5 μL, less than about 2.0 μL, less than about 2.5 μL, less than about 3.0 μL, and less than about 3.5 μL or more. This increase in droplet volume increases the dilution volume available for various processes used in conjunction with the OPI. In an example, samples may be introduced into the droplet 300 by known methods, such as dropping samples from above into the droplet 300. In other examples, an SPME device 302 is introduced to the droplet 300. The SPME device 302 may have a large active area 302a that may benefit from interaction with the enlarged droplet 300, so as to dilute a larger portion of constituents thereon.

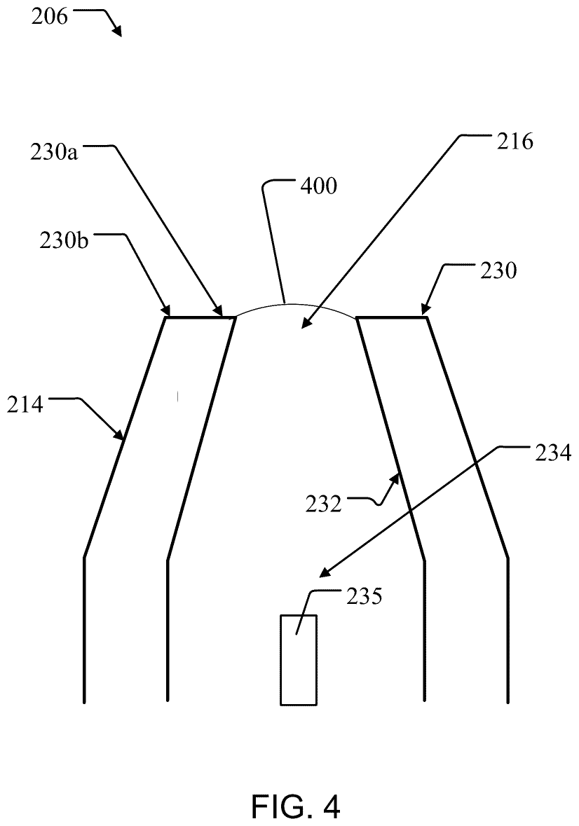

FIG. 4 depicts a configuration where a sample inlet tip 206 having an inner terminal surface region 230a with a high hydrophilicity is depicted. In this example, the inner terminal surface region 230a has a higher hydrophilicity than an adjacent region (e.g., outer terminal surface region 230b), which prevents a large dome from forming at the sample inlet tip 206. Thus, a small droplet 400 is formed. The high hydrophilicity of the inner terminal surface region 230a prevents a build-up of liquid thereon (transport liquid may instead flow off of the terminal surface 230 if too large of a droplet is formed). This greatly reduces the total dilution volume at the sample inlet tip 206. This decrease in droplet volume increases the dilution volume available for various processes used in conjunction with the OPI.

The size of the droplets 300, 400 formed at the sample inlet tips 206, as depicted in FIGS. 3 and 4 are a function of one or more of a geometry (e.g., diameter) of the sample inlet port 216, the type of transport liquid (e.g., as characterized by viscosity), the tip hydrophobicity/hydrophilicity (e.g., relative measure and type), the location of the hydrophobic/hydrophilic surface (e.g., on the inner wall 232, on the tip surface 214, etc.), the OPI application (e.g., upward- or downward-facing), etc. For downward-facing applications of an OPI, sample inlet tips having increased hydrophilic performance may be desirable for a number of applications.

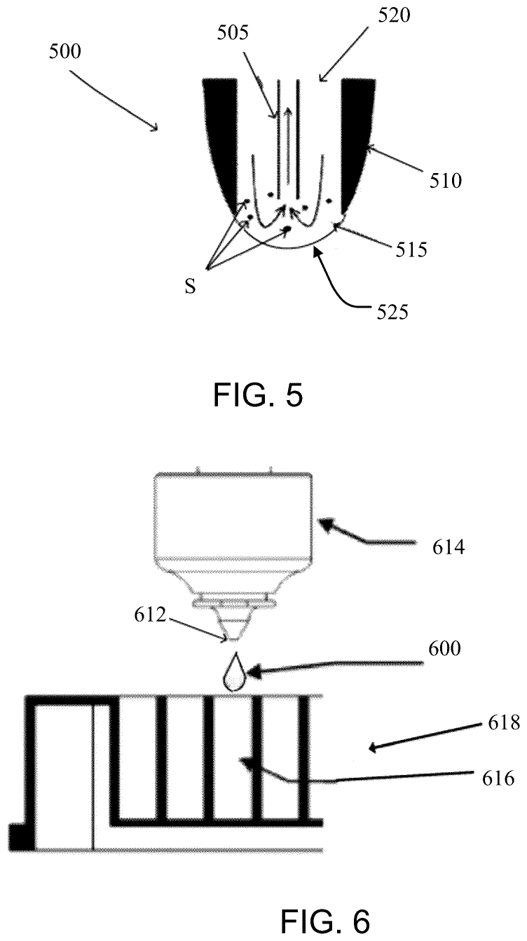

FIG. 5 is a partial enlarged schematic sectional view of an OPI 500. The OPI 500 can have a variety of configurations but generally includes an outer housing 510 defining a sample inlet port 515 by which a sample is introduced to the OPI 500. In an example, the sample is delivered in a contact-free manner from a reservoir such as a well plate or microplate or the sample may be directly introduced to the sample port 515, which is open to the atmosphere, thus exhibiting a liquid-air interface for capturing the sample (depicted generally at S). The sample S may contain or be suspected of containing one or more analytes. In some examples, the OPI 500 may also include a removal conduit 505 for exhausting transport liquid solvent from an interior volume 520 of the OPI 500. The transport liquid solvent forms a meniscus 525 at the sample inlet port 515 that receives the samples S ejected from the microplate. That meniscus 525 may extend at least partially below the bottom more portion of the OPI 500, at the sample inlet port 515. In the event of insufficient aspiration, an amount of solvent may accumulate at the open end of the sampling probe, forming a domed liquid shape. The surface tension of the solvent causes the drop to hang from the bottom of the sampling probe, forming a pendant. When the drop exceeds a certain weight, it is no longer stable and detaches itself and falls under gravitational force into the samples below, causing contamination.

FIG. 6 depicts formation of a liquid droplet 600 at a sample inlet port 612 of an OPI 614. In the depicted example, samples may be ejected from a well 616 of a microplate 618. The ejected samples enter the sample inlet port 612 of an OPI 614, e.g., after being acoustically ejected from a sample well 616 of a microplate 618, and directly into the liquid present within the interior volume of the OPI 614. It will likewise be appreciated by those skilled in the art, that any liquid (e.g., solvent) suitable for directly receiving a liquid sample may be utilized. In other examples, the sample may comprise a solid sample that may be introduced directly into the liquid present within the OPI 614 for dissolution. In some examples, the solid sample can comprise solid phase substrates having binding affinity for a selected protein of a drug molecules, such as SPME fibers or magnetic particles, as described above in the context of FIG. 3.

In FIG. 6, a solvent liquid droplet 600 is shown dropping from the sample inlet port 612 as a result of, for example, insufficient aspiration of the solvent from the OPI 614. During proper operation, as noted above in FIG. 5, the transport liquid solvent forms a meniscus at the sample inlet port 612 of the OPI 614. However, upon exceeding a certain weight, a liquid droplet 600 detaches itself from the OPI 614 and falls under gravitational force into a well 616 or otherwise onto the microplate 618, thereby causing contamination.

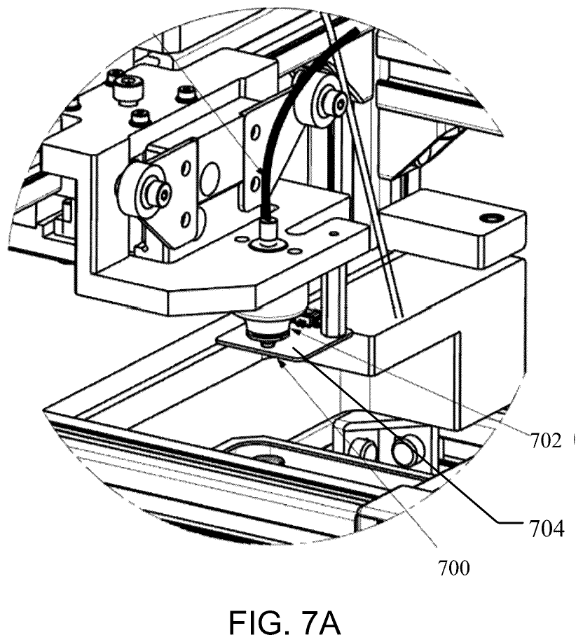

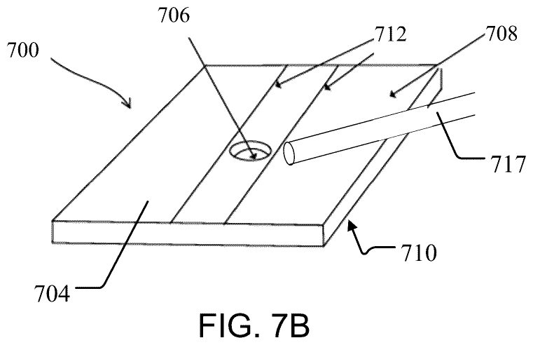

FIG. 7A depicts an apparatus 700 for detecting droplets of liquid at a sample inlet port of an OPI 702. This detection may occur prior to release of the droplet from the OPI 702, which may allow for removal of the microplate from below the OPI 702, increase in aspiration rate of the transport liquid solvent from the OPI 702, shutdown of the system, or other action. The apparatus 700 includes a substrate 704 or plate that is disposed adjacent the OPI 702. One example substrate 704 is depicted in FIG. 7B. The substrate 702 of the apparatus 700 defines an orifice 706 that extends therethrough, from an upper surface 708 to a lower surface 710. The orifice 706 is configured to accommodate at least a portion of the OPI 702 without contacting the edges of the orifice 706. Further details with regard to the location of the substrate 704 relative to the OPI is described below in the context of FIG. 5. The OPI 702 is configured to allow of transport liquid solvent on an outer surface of the OPI 702. The outer housing of the OPI 702 may be hydrophilic in nature, thereby enabling movement of excess transport liquid solvent upwards from the sample inlet port towards the upper surface 708 of the substrate 704, as described below. At the upper surface 708, the droplet comes into contact with a sensor 712 on the upper surface 708.

The sensor 712 detects transport liquid solvent that climbs the outer housing of the OPI 702, as described below, and generates a signal to a controller (such as controller 130 of FIG. 1) for reducing or halting supply of transport liquid solvent flow to the OPI 702, while continuing aspiration to exhaust the excess transport liquid solvent from the sample inlet port. In this manner, the droplet is arrested and may be removed before it overflows onto or into the microplate. In some examples, the controller may be further operative to increase the flow of nebulizing gas to correspondingly increase aspiration at the sample inlet port of the OPI 702. In aspects, the controller may be operative to maintain the transport liquid solvent flow supply to the OPI 702 at a constant flow rate while increasing the flow of nebulizing gas to increase aspiration. In examples, locating the sensor 712 on the top surface 708, away from incoming ejection droplets from the microplate, reduces or eliminates interference by any electric field from sensor 712 to the sample ejection trajectory. Acoustically ejected nano droplets are quite sensitive to charge, and uncontrolled electrostatic charges are known to affect the volume and/or the trajectory of the droplets, such as described in U.S. Pat. No. 7,070,260. In examples where the sensor 712 does not generate sufficient charge to affect acoustic ejection of sample droplets, the sensor 712 may be located on the bottom surface 710 or on the perimeter wall of the orifice 706, as required or desired for a particular application.

Experiments have shown that apparatus 700 retains the overflowed solvent and prolongs the time taken for the actual liquid dripping from the OPI 702 to occur from about 30 msec to about 30 sec, which is sufficient time to halt or modify the acquisition process and generate a notification signal for alerting operators of the overflow condition and/or correct the problem by aspirating off the overflow liquid. In other examples, the sensor 712 is one of either an electrically conductive trace or a conductive wire, located for instance on the upper surface 708, to detect a change in resistance upon contact with solvent, or a temperature sensor, such as a thermocouple or a resistance thermometer, to detect change in temperature when in contact with solvent. In another example, a change in capacitance may be detected by the sensor. In other examples, an accessory capillary tube 714 may be located to aspirate the overflow liquid away from the sensor 712 before the liquid drips to the microplate.

Experimentation has shown that the viscosity characteristics of a transport liquid solvent are such that it may “creep up” the tapered outer housing of an OPI 702, so as to contact the sensor 712, before it has enough weight to form a drop. Based on a 200 μl/min flow rate, droplet formation has been observed to occur in approximately 30 msec with an imbalance between transport liquid solvent supply to the OPI 702 and exhausting of solvent by aspiration at the open end due to flow of nebulizing gas. This creep is described in PCT Publication No. WO 2021/234674, entitled “Overflow Sensor for Open Port Sampling,” the disclosure of which is incorporated by reference herein in its entirety. While the solutions provided in PCT Publication No. WO 2021/234674 are useful for the particular configuration described therein, certain configurations of OPIs and mass analysis systems using such OPIs are not amenable to such solutions. As such, the present disclosure describes additional technologies that may be incorporated into OPIs that may improve performance. Such technologies are described further below.

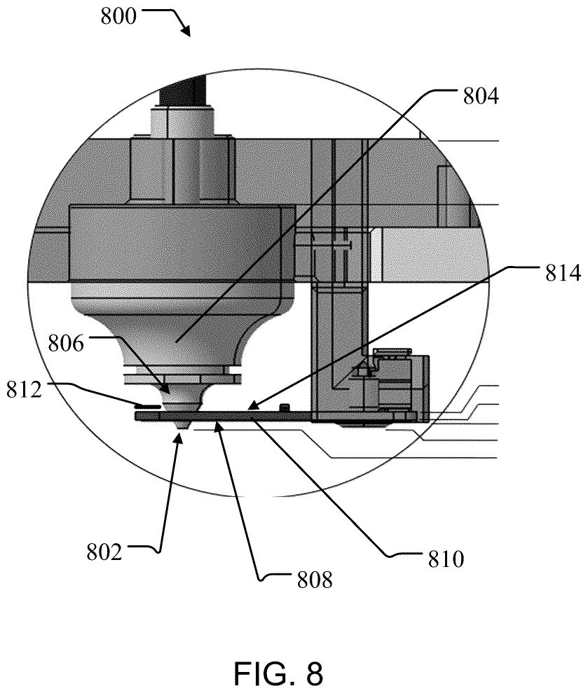

FIG. 8 is a side view of an apparatus 800 for detecting droplets of liquid at a sample inlet port 802 of an OPI 804. Notably, and unlike the OPI depicted in FIG. 8 of PCT Publication No. WO 2021/234674, a portion of an outer housing 806 of the OPI 804 extends below a lower surface 808 of a substrate 810 (through an opening, such as described above in the context of FIG. 7B). A transport liquid sensor 812 is disposed adjacent the opening and the OPI 804 on an upper surface 814 of the substrate 810. Thus, in this configuration, samples delivered into the OPI 804 are received at a position well below the sensor 812, which reduces the possibility of the sensor 812 interfering with the trajectory of the sample. While such a configuration, with the sample inlet port 802 disposed below the lower surface 808 is advantageous, in that it prevents unwanted electrostatic charge from effecting the trajectory of the ejected sample, such a configuration limits the applicability of the technologies described in PCT Publication No. WO 2021/234674. In some examples, the sample inlet port is disposed at least 0.5 mm below the lower surface of the sensor plate, which may be mounted on a substrate having a thickness of between about 0.5 mm and 0.8 mm. Where the OPI 804 is disposed in the plane of the upper surface 814, a separation distance between the outer housing and the upper surface 814 is about 0.3 mm. Even at these and other distances, the hydrophilic technologies described herein may retain such a volume of liquid on the OPI so as to allow that liquid to contact the sensor 812.

As such, OPIs described in the context of FIGS. 4-8 have applied to the outer housing thereof a hydrophilic coating or hydrophilic treatment (e.g., subjecting the material to a physical process) that improves adhesion of excess transport liquid solvent to the outer housing of the OPI 804. In other examples, the outer housing may be manufactured of a hydrophilic material such as a hydrophilic polymer. Hydrophilic coatings, treatments, or materials improve adhesion to a degree that excess liquid climbs the outer housing 806 of the OPI 804, through the orifice in the substrate 810, and into contact with the sensor 812, when the OPI is in a downward-facing position.

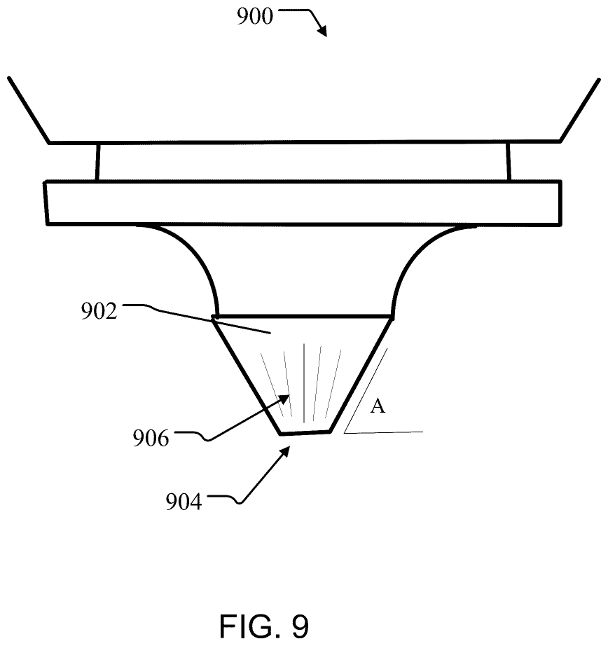

In an example, the technologies described herein contemplate a coating different than the material of the outer housing be applied to the outer housing, so as to increase desirable performance. The coating may be applied while in a liquid state, for example, by dipping the OPI into the coating or by spraying the coating at the OPI. In examples, multiple applications of the coating may be performed. FIG. 9 depicts an example of an OPI 900 to explain performance of the hydrophobic or hydrophilic coatings, treatments, or materials. The OPI 900 includes an outer housing 902 that defines a sample inlet port 904. The outer housing 902 includes walls that may be disposed at an angle A from horizontal of about 5 degrees, about 10 degrees, about 15 degrees, about 20 degrees, about 25 degrees, about 30 degrees, or about 35 degrees to the horizontal. At these angles, a hydrophilic coating such as Liquid P100, available from Jonsman Innovation ApS of Gorlose, Denmark, displays acceptable performance. Liquid P100 has a long functional life, is biocompatible, adheres well to many materials, and is comprised mainly of isopropanol. Another hydrophilic coating may be ON-470 available from Aculon of San Diego, California, USA. Another coating may be trifluoroethanol from Aculon. The hydrophilic coatings described herein may particularly useful with compositions of about 30% water mixed with solvent such as methanol or acetonitrile. Hydrophobic coatings such as TEFLON may also be utilized, as well as so-called superhydrophobic coatings that may be silica-based and applied as a gel or aerosol spray. In another example, a hydrophilic treatment may be applied to the outer housing 902, so as to increase the hydrophilic performance thereof. Electrowetting processes may also be utilized to change or otherwise adjust the hydrophobicity/hydrophilicity of the material utilized to manufacture the OPI. In other examples, laser or plasma etching may be used, for example, to form one or more microcapillaries 906 in the outer housing 902. Microcapillaries 906 may be particularly advantageous for hydrophilic applications, as they provide a flow path for liquids.

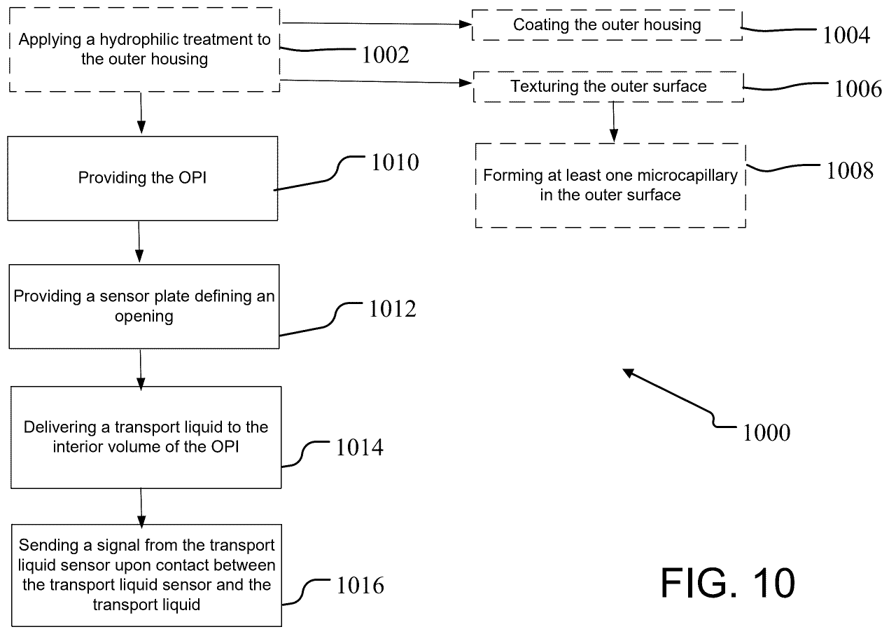

FIG. 10 depicts a method 1000 for detecting a liquid overflow condition from an OPI. The OPI may include an outer housing and a downward-facing sample inlet port, such as described elsewhere herein, as well as an interior volume communicatively coupled to the sample inlet port. The method 1000 may begin with operation 1002, applying a hydrophilic treatment to an outer housing of the OPI. In examples, operation 1002 includes at least one of coating the outer housing with a hydrophilic coating (operation 1004) and texturing the outer surface (operation 1006). In examples, texturing the outer surface includes forming at least one microcapillary in the outer surface, operation 1008. Thereafter, the OPI may be provided, operation 1010. In another example of operation 1010, the OPI provided may be manufactured of a hydrophilic material. In still other examples, an OPI manufactured of a hydrophilic material may be further coated and/or treated, as per operations 1004 and 1006. In operation 1012, a sensor plate defining an opening is provided. At least a portion of the outer housing is at least partially within the opening, and the sensor plate includes a transport liquid sensor disposed on an upper surface thereof. Further the sample inlet port of the OPI is disposed below the upper surface. In operation 1014, a transport liquid is delivered to the interior volume of the OPI. A signal is sent from the transport liquid sensor upon contact between the transport liquid sensor and the transport liquid, operation 1016. As described elsewhere herein, the hydrophilic nature of the outer housing of the OPI enable detection by the sensor of the presence of the liquid, even though the sensor is disposed well above the sample inlet port.

The technologies described herein may be utilized to optimize performance of an OPI for a particular application. Performance may be optimized by selecting a particular sample inlet tip from a plurality of sample inlet tips, each displaying different hydrophobic/hydrophilic performance. Further considerations in selecting a desirable sample inlet tip include the type of transport liquid utilized (and its attendant viscosity), the OPI orientation (upward- or downward-facing), inlet port diameter, and other factors. Thus, an OPI may be designed for a particular application, built to specification, and sent to a laboratory for immediate use.

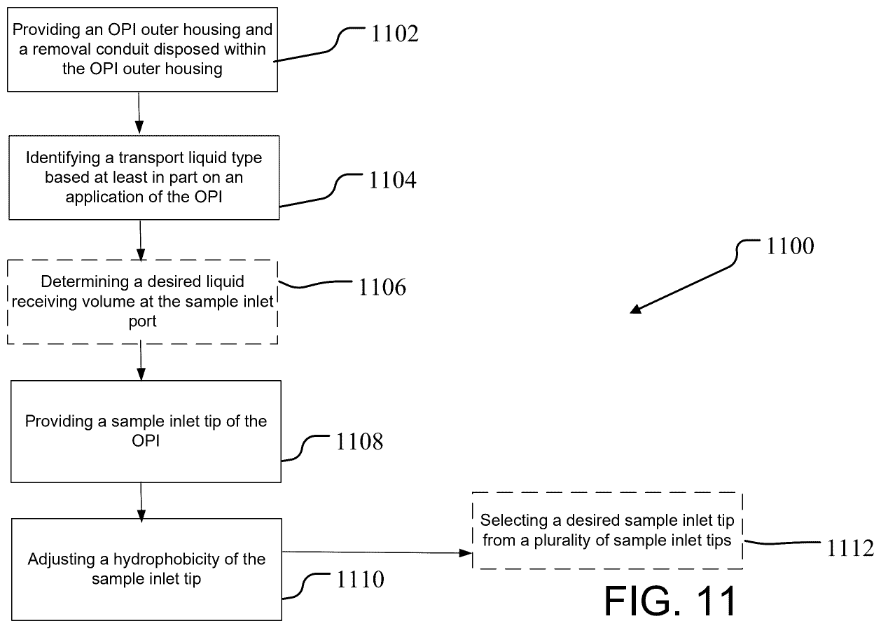

FIG. 11 depicts a method 1100 of manufacturing an OPI, addressing a number of the above considerations. Operation 1102 includes providing an OPI outer housing and a removal conduit disposed within the OPI outer housing. Such components are known in the art and are described elsewhere herein. Another factor that may be considered when providing the OPI outer housing may include the required or desired internal volume thereof (for appropriate sample dilution). The inflow and outflow transport liquid rates may also be considered. Those rates may be based at least in part on other components within an analysis system, such as the transport liquid pump and ionization element. Operation 1104 includes identifying a transport liquid type based at least in part on an application of the OPI which, as noted elsewhere herein, may be particularly relevant in determining desired transport liquid dome size. In an optional operation 1106, a desired liquid receiving volume at the sample inlet port may be determined. This may be particular useful in application where very large domes are desired for increased sample dilution or if the OPI application involves the use of SPME devices (e.g., as described above in the context of FIG. 3). Operation 1108 includes providing a sample inlet tip of the OPI that has a particular sample inlet port geometry. This aspect too may be a function of OPI application, sample introduction system type, etc. With these known or desired parameters in mind, the desired hydrophobicity/hydrophilicity for the particular application may be determined. Operation 1110 includes adjusting a hydrophobicity of the sample inlet tip based at least in part on the sample inlet port geometry and the identified transport liquid type, as determined above. In an example of the method where optional operation 1106 is performed, adjustment of the hydrophobicity may also be based at least in part on the determination of the desired liquid receiving volume (e.g., the dome size). In examples, the adjustment referred to in operation 1110 includes selecting a desired sample inlet tip from a plurality of sample inlet tips, each of which has a different hydrophobicity.

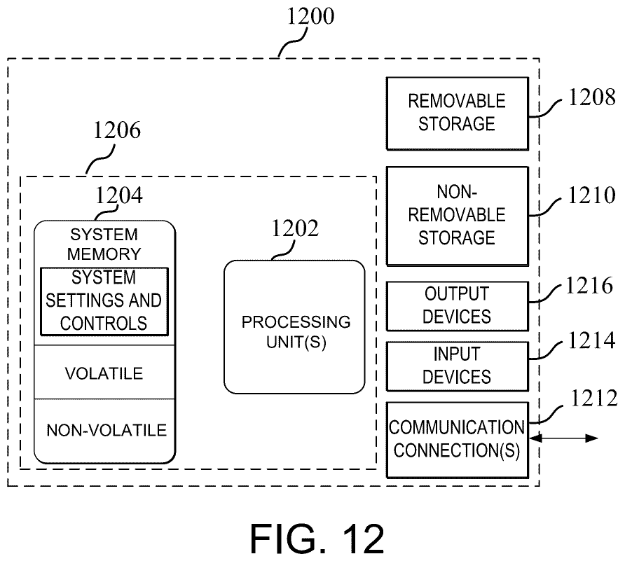

FIG. 12 depicts one example of a suitable operating environment 1200 in which one or more of the present examples can be implemented. This operating environment may be incorporated directly into the controller for a mass spectrometry or other mass analysis system, e.g., such as the controller depicted in FIG. 1. This is only one example of a suitable operating environment and is not intended to suggest any limitation as to the scope of use or functionality. Other well-known computing systems, environments, and/or configurations that can be suitable for use include, but are not limited to, personal computers, server computers, hand-held or laptop devices, multiprocessor systems, microprocessor-based systems, programmable consumer electronics such as smart phones, network PCs, minicomputers, mainframe computers, tablets, distributed computing environments that include any of the above systems or devices, and the like.

In its most basic configuration, operating environment 1200 typically includes at least one processing unit 1202 and memory 1204. Depending on the exact configuration and type of computing device, memory 1204 (storing, among other things, instructions to control the transport liquid pump and/or gas source in response to sensor signals, system power, etc., or perform other methods disclosed herein) can be volatile (such as RAM), non-volatile (such as ROM, flash memory, etc.), or some combination of the two. This most basic configuration is illustrated in FIG. 12 by dashed line 1206. Further, environment 1200 can also include storage devices (removable, 1208, and/or non-removable, 1210) including, but not limited to, magnetic or optical disks or tape. Similarly, environment 1200 can also have input device(s) 1214 such as touch screens, keyboard, mouse, pen, voice input, etc., and/or output device(s) 1216 such as a display, speakers, printer, etc. Also included in the environment can be one or more communication connections 1212, such as LAN, WAN, point to point, Bluetooth, RF, etc.

Operating environment 1200 typically includes at least some form of computer readable media. Computer readable media can be any available media that can be accessed by processing unit 1202 or other devices having the operating environment. By way of example, and not limitation, computer readable media can include computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, solid state storage, or any other tangible medium which can be used to store the desired information. Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media. A computer-readable device is a hardware device incorporating computer storage media.

The operating environment 1200 can be a single computer operating in a networked environment using logical connections to one or more remote computers. The remote computer can be a personal computer, a server, a router, a network PC, a peer device or other common network node, and typically includes many or all of the elements described above as well as others not so mentioned. The logical connections can include any method supported by available communications media. Such networking environments are commonplace in offices, enterprise-wide computer networks, intranets and the Internet.

In some examples, the components described herein include such modules or instructions executable by computer system 1200 that can be stored on computer storage medium and other tangible mediums and transmitted in communication media. Computer storage media includes volatile and non-volatile, removable and non-removable media implemented in any method or technology for storage of information such as computer readable instructions, data structures, program modules, or other data. Combinations of any of the above should also be included within the scope of readable media. In some examples, computer system 1200 is part of a network that stores data in remote storage media for use by the computer system 1200.

This disclosure described some examples of the present technology with reference to the accompanying drawings, in which only some of the possible examples were shown. Other aspects can, however, be embodied in many different forms and should not be construed as limited to the examples set forth herein. Rather, these examples were provided so that this disclosure was thorough and complete and fully conveyed the scope of the possible examples to those skilled in the art.

Although specific examples were described herein, the scope of the technology is not limited to those specific examples. One skilled in the art will recognize other examples or improvements that are within the scope of the present technology. Therefore, the specific structure, acts, or media are disclosed only as illustrative examples. Examples according to the technology may also combine elements or components of those that are disclosed in general but not expressly exemplified in combination, unless otherwise stated herein. The scope of the technology is defined by the following claims and any equivalents therein.

What is claimed is:

1. An open port interface comprising:
an outer housing defining:
an interior volume; and
a transport liquid port communicatively coupled to the interior volume and configured to be fluidically coupled to a transport liquid pump;
a removal conduit disposed within the outer housing and fluidically coupled to the interior volume for removing a transport liquid from the interior volume; and
a sample inlet tip removably coupled to the outer housing, wherein the sample inlet tip defines a sample inlet port configured to receive a sample and communicatively coupled to the interior volume, wherein at least a portion of the sample inlet tip proximate the sample inlet port comprises a tip surface having a hydrophobicity different than a hydrophobicity of the outer housing.

2. The open port interface of claim 1, wherein the tip surface comprises at least one of a one of a hydrophobic material, a hydrophobic coating, and a hydrophobic surface treatment.

3. The open port interface of claim 1, wherein the sample inlet tip comprises a ring-shaped terminal surface, wherein the ring-shaped terminal surface defines the sample inlet port, and wherein at least a portion of the ring-shaped terminal surface comprises the tip surface having the hydrophobicity different than the hydrophobicity of the outer housing, and wherein the ring-shaped terminal surface comprises an inner terminal surface region proximate the sample inlet port and an outer terminal surface region distal the sample inlet port.

4. (canceled)

5. The open port interface of claim 4, wherein the inner surface region comprises the tip surface having the hydrophobicity different than the hydrophobicity of the outer housing.

6. The open port interface of claim 4, wherein the outer surface region comprises the tip surface having the hydrophobicity different than the hydrophobicity of the outer housing.

7. The open port interface of claim 2, wherein the sample inlet tip comprises an inner wall defining a receiving volume fluidically coupled to the interior volume and the sample inlet port, and wherein at least a portion of the sample inlet tip inner wall comprises the tip surface having the hydrophobicity different than the hydrophobicity of the outer housing.

8. The open port interface of claim 1, wherein the tip surface comprises at least one of a one of a hydrophilic material, a hydrophilic coating, and a hydrophilic surface treatment.

9. The open port interface of claim 8, wherein the hydrophilic coating comprises at least one of a nanoparticle coating and substantially isopropanol.

10. (canceled)

11. (canceled)

12. The open port interface of claim 8, wherein the hydrophilic surface treatment comprises a plurality of microcapillaries.

13. The open port interface of claim 8, wherein the hydrophilic surface treatment comprises a plasma treatment.

14-16. (canceled)

17. A method of detecting a liquid overflow condition from a downward-facing open port interface (OPI), the method comprising:
providing the OPI comprising an outer housing, an interior volume, and a sample inlet tip defining a sample inlet port communicatively coupled to the interior volume;
providing a sensor plate defining an opening, wherein at least a portion of the outer housing is at least partially within the opening, wherein the sensor plate comprises a transport liquid sensor disposed on an upper surface of the sensor plate, and wherein the sample inlet port of the OPI is disposed below the upper surface;
delivering a transport liquid to the interior volume of the OPI; and
sending a signal from the transport liquid sensor upon contact between the transport liquid sensor and the transport liquid.

18. The method of claim 17, further comprising applying a hydrophilic treatment to the sample inlet tip.

19. The method of claim 17, wherein applying the hydrophilic treatment comprises at least one of coating the sample inlet tip with a hydrophilic coating and texturing the sample inlet tip.

20. The method of claim 19, wherein texturing the sample inlet tip comprises forming at least one microcapillary in the sample inlet tip.

21. A mass analysis system comprising:
(a) a sensor plate comprising:
an upper surface;
a lower surface, wherein the sensor plate defines an opening from the upper surface to the lower surface; and
a transport liquid sensor disposed adjacent the opening on the upper surface of the sensor plate;
(b) a sample introduction system disposed below the lower surface;
(c) a transport liquid pump; and
(d) an open port interface comprising:
an outer housing defining:
an interior volume; and
a transport liquid port communicatively coupled to the interior volume and configured to be fluidically coupled to the transport liquid pump;
a removal conduit disposed within the outer housing and fluidically coupled to the interior volume for removing a transport liquid from the interior volume; and
a sample inlet tip removably coupled to the outer housing, wherein the sample inlet tip defines a sample inlet port configured to receive a sample and communicatively coupled to the interior volume, wherein the sample inlet port is disposed below the upper surface, wherein at least a portion of the sample inlet tip proximate the sample inlet port comprises a tip surface having a hydrophilicity different than a hydrophilicity of the outer housing, and wherein the transport liquid sensor contacts an exit volume of the transport liquid that exits the outer housing via the sample inlet port.

22. The mass analysis system of claim 21, wherein the tip surface comprises at least one of a hydrophilic material, a hydrophilic coating, and a hydrophilic surface treatment for moving the exit volume of the transport liquid towards the transport liquid sensor.

23-25. (canceled)

26. The mass analysis system of claim 22, wherein the hydrophilic coating comprises one of a nanoparticle coating and substantially isopropanol.

27. (canceled)

28. (canceled)

29. The mass analysis system of claim 22, wherein the hydrophilic surface treatment comprises a plurality of microcapillaries.

30. The mass analysis system of claim 22, wherein the hydrophilic surface treatment comprises a plasma treatment.

31. The mass analysis system of claim 22, wherein the sample introduction system comprises a contactless ejection system.
